(19) United States
(12) Patent Application Publication
(10) Pub. No.: US 2006/0181771 A1
(43) Pub. Date: Aug. 17, 2006

(54) Projection type screen and image projection system

(75) Inventor: Kazuki Taira, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/352,245

(22) Filed: Feb. 13, 2006

(30) Foreign Application Priority Data
Feb. 14, 2005 (JP) P2005-036574

(51) Int. Cl. G02B 5/30

(52) U.S. Cl. 359/494; 359/483

(57) ABSTRACT

A first polarizer transmits incident light of a first polarized direction and absorbs incident light of a polarized direction different from the first polarized direction. A birefringent film layer rotates a polarized direction of light of a predetermined wavelength to a second polarized direction different from the first polarized direction in a light transmitted through the first polarizer. A second polarizer transmits light of the first polarized direction and reflects a light of the second polarized direction in a light transmitted through the birefringent film layer. A substrate absorbs light transmitted through the second polarizer.

### CROSS-REFERENCE TO RELATED APPLICATIONS

This application is based upon and claims the benefit of priority from prior Japanese Patent Application No.2005-36574, filed on Feb. 14, 2005; the entire contents of which are incorporated herein by reference.

### FIELD OF THE INVENTION

The present invention relates to a projection type screen and image projection system for obtaining a projection image with high contrast.

### BACKGROUND OF THE INVENTION

Known MEMS (Micro-Electro-Mechanical System) display devices include, a DLP (Digital Light Processing) projector using DMD (Digital micro Mirror Device), and a liquid crystal projector using a liquid crystal display device. These projectors are called an image projection system of projection type. In the image projection system, a light outgoing from a projection lens of the projector is projected onto a screen, and an image is projected onto the screen by a reflection light.

In this image projection system, in order for an observer to easily view a projected image on the screen, it is important to a high keep contrast of the projected image on the screen. Especially, in not a darkroom but a bright room to which a sunshine or an indoor illumination is incident, in case of observing the projected image on the screen, a stray light such as the sunshine or the indoor illumination is superimposed onto a projection light from the liquid crystal projector. As a result, contrast of the image falls.

In order to solve this problem, by utilizing a difference between a wavelength region of the projection light from the projector and a wavelength region of the stray light, a light of predetermined wavelength is selectively reflected in a light incident to the screen. As a result, contrast of the projected image rises.

As a screen to selectively reflect a light of predetermined wavelength, for example, a screen using an optical thin film selectively transmitting a light of predetermined wavelength (Japanese Patent Disclosure (Kokai) 2004-219901, Page 5 and FIG. 1), and a screen using selective reflection of circularly polarized light of Cholesteric liquid crystal film (M. Umeda, M. Hatano and N. Egashira, “New Front-Projection Screen comprised of Cholesteric-LC Films”, SID 04 DIGEST, pp. 842-845, 2004) are disclosed.

In a method using the optical thin film, a screen is formed by multiply laminating thin films each having a different refractive index on a screen material of substrate with strict control of cell gap. As a method for forming such thin film, in general, a vapor deposition method is used. However, in case of forming thin films using the vapor deposition method, it is often difficult to form a uniform thin film. As a result, in a screen created using this method, high contrast cannot be realized. Especially, if an area of the screen becomes large, it is difficult to uniformly form a thin film on the entire screen. Briefly, high contrast cannot be realized on the screen of large area.

Furthermore, in a method using selective reflection of circularly polarized light of Chorestric liquid crystal film, after coating a liquid crystal layer on the screen material of substrate, an alignment process to transit a phase status of the liquid crystal layer onto a planar phase having selective reflection of circularly polarized light by applying share stress is necessary. However, in case of the screen of large area, selective reflection of circularly polarized light cannot be uniformly formed. Accordingly, in this method, the screen having sufficient contrast cannot be obtained.

As mentioned-above, in a screen using the optical thin film and a screen using selective reflection of circularly polarized light of Chorestric liquid crystal film, a projection image with high contrast cannot be obtained.

### SUMMARY OF THE INVENTION

The present invention is directed to a projection type screen and image projection system able to obtain a projection image with high contrast by separating a projection light from a stray light each incident on a screen and reflecting the projection light.

According to an aspect of the present invention, there is provided a projection type screen, comprising: a first polarizer configured to transmit a light of a first polarized direction and absorb a light of a polarized direction different from the first polarized direction in an incident light; a birefringent film layer located at the back of the first polarizer along a direction of the incident light, configured to rotate a polarized direction of a light of a predetermined wavelength to a second polarized direction different from the first polarized direction in a light transmitted through the first polarizer; a second polarizer located at the back of the birefringent film layer along the direction of the incident light, configured to transmit a light of the first polarized direction and reflect a light of the second polarized direction in a light transmitted through the birefringent film layer; and a material of substrate located at the back of the second polarizer along the direction of the incident light, configured to absorb a light transmitted through the second polarizer.

According to another aspect of the present invention, there is also provided a projection type screen, comprising: a first polarizer configured to transmit a light of a first polarized direction and absorb a light of a polarized direction different from the first polarized direction in an incident light; a birefringent film layer located at the back of the first polarizer along a direction of the incident light, configured to rotate a polarized direction of a light of a predetermined wavelength to a second polarized direction different from the first polarized direction in a light transmitted through the first polarizer; a second polarizer located at the back of the birefringent film layer along the direction of the incident light, configured to reflect a light of the first polarized direction and transmit a light of the second polarized direction in a light transmitted through the birefringent film layer; and a material of substrate located at the back of the second polarizer along the direction of the incident light, configured to absorb a light transmitted through the second polarizer.

### BRIEF DESCRIPTION OF THE DRAWINGS

FIG. 1 shows a component of a projection type screen according to a first embodiment of the present invention.

FIG. 2 is a schematic diagram of an image projection system using the projection type screen according to the first embodiment.

FIG. 3 is a schematic diagram showing a relationship between the projection type screen and a projection light according to the first embodiment.

FIG. 4 is a component of a light emitting apparatus according to the first embodiment.

FIG. 5 is a schematic diagram showing a function of a first polarizer of the projection type screen according to the first embodiment.

FIG. 6 shows a component of a birefringent film layer of the projection type screen according to the first embodiment.

FIG. 7 is a schematic diagram showing a relationship between a fast axis and a slow axis of the birefringent film layer according to the first embodiment.

FIG. 8 explains a design example of the birefringent film layer of the projection type screen according to the first embodiment.

FIG. 9 is a graph of filter characteristic of a first birefringent film layer of the projection type screen according to the first embodiment.

FIGS. 10A and 10B are schematic diagrams showing function of the first birefringent film layer of the projection type screen according to the first embodiment.

FIG. 11 is a graph of filter characteristic of a second birefringent film layer of the projection type screen according to the first embodiment.

FIG. 12 is a graph of filter characteristic of a third birefringent film layer of the projection type screen according to the first embodiment.

FIG. 13 is a graph of filter characteristic of the birefringent film layer of the projection type screen according to the first embodiment.

FIG. 14 is a schematic diagram showing function of the birefringent film layer of the projection type screen according to the first embodiment.

FIG. 15 is a schematic diagram showing a function of a second polarizer of the projection type screen according to the first embodiment.

FIG. 16 is a schematic diagram showing a function of the birefringent film layer of the projection type screen for a reflection light according to the first embodiment.

FIG. 17 shows a component of a projection type screen according to a second embodiment of the present invention.

FIG. 18 is a graph of filter characteristic of a first birefringent film layer of the projection type screen according to the second embodiment.

FIG. 19 is a graph of filter characteristic of a second birefringent film layer of the projection type screen according to the second embodiment.

FIG. 20 is a graph of filter characteristic of the birefringent film layer of the projection type screen according to the second embodiment.

FIG. 21 is a schematic diagram showing function of the birefringent film layer of the projection type screen according to the second embodiment.

FIG. 22 is a schematic diagram showing a function of a second polarizer of the projection type screen according to the second embodiment.

### DETAILED DESCRIPTION OF THE EMBODIMENTS

Hereinafter, various embodiments of the present invention will be explained by referring to the drawings. The present invention is not limited to following embodiments.

### The First Embodiment

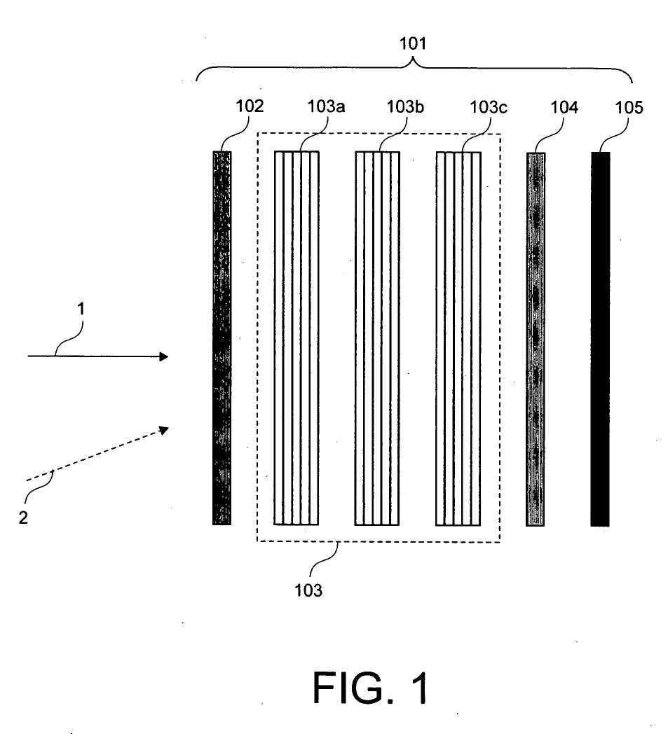

FIG. 1 is a block diagram of component of a projection type screen 101 according to a first embodiment of the present invention.

The projection type screen 101 of the first embodiment comprises the following units. A first polarizer 102 transmits incident light of a first polarized direction and absorbs incident light of a polarized direction different from the first polarized direction. A birefringent film layer 103 rotates a polarized direction of light transmitted through the first polarizer 102 of predetermined wavelengths to a direction perpendicular to the first polarized direction. A second polarizer 104 transmits a light of a polarized direction the same as the first polarized direction, and reflects a light of a polarized direction different from the first polarized direction. A substrate screen material 105 absorbs light transmitted through the second polarizer 104. Hereinafter, the polarized direction of light transmitted through the first polarizer 102 and the second polarizer 104 is called a transmission axis of polarized axis of each polarizer.

The birefringent film layer 103 comprises following units. A first birefringent film layer 103a rotates a polarized direction of blue light to a direction perpendicular to a transmission axis of polarized axis of the polarizer 102. A second birefringent film layer 103b rotates a polarized direction of green light to a direction perpendicular to a transmission axis of polarized axis of the polarizer 102. A third birefringent film layer 103c rotates a polarized direction of red light to a direction perpendicular to a transmission axis of polarized axis of the polarizer 102.

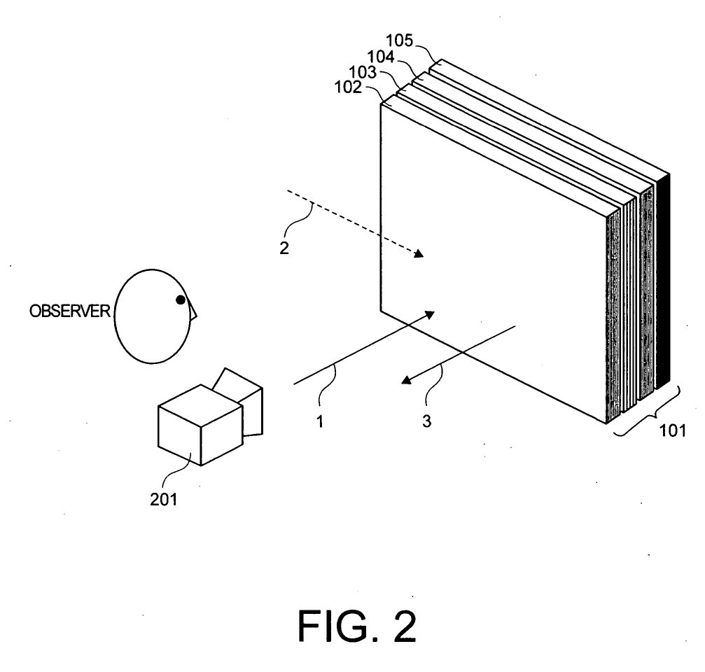

FIG. 2 is a schematic diagram of an image projection system using the projection type screen according to the first embodiment. As shown in FIG. 2, a light emitting apparatus 201 for emitting a projection light 1 (including image data to be projected onto the projection type screen such as a liquid crystal projector) is located at a front side of the first polarizer 102 for the projection type screen 101. A projection light 1 outgoing from the light emitting apparatus 201 is incident to the projection type screen 101, and an image is projected from the projection type screen 101 by reflecting the projection light 1 as a reflection light 3. An observer views a projection image on the projection type screen 101 from the same side as the light emitting apparatus 201.

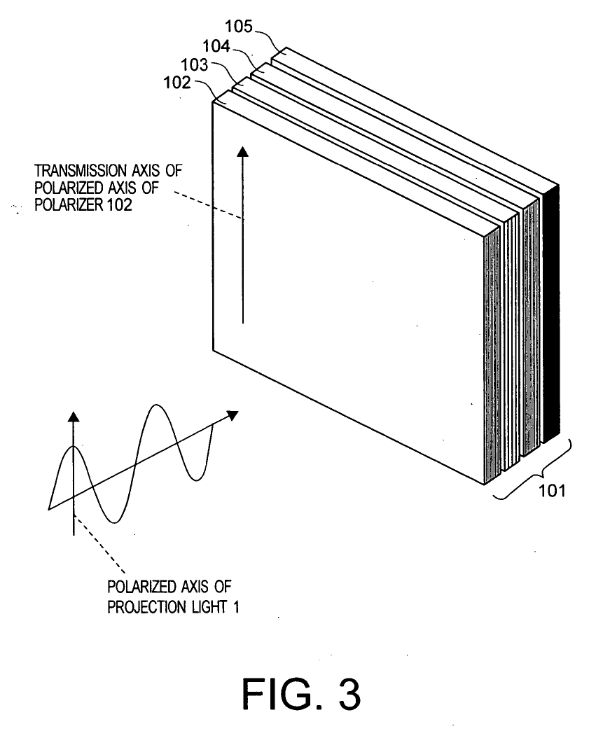

Next, the function of the projection type screen of the first embodiment is explained by referring to FIGS. 3-16.

First, as shown in FIG. 3, a projection light 1 outgoing from the light emitting apparatus 201 (such as the liquid crystal projector) is incident to the polarizer 102. Furthermore, a stray light such as an indoor illumination or sunshine is superimposed with the projection light 1 and is incident to the polarizer 102.

The projection light 1 outgoing from the light emitting apparatus 201 is comprised of three primary colors (blue (B), green (G), red (R)). Furthermore, in order to extend reappearance range of projected image on the projection type screen 101, light elements corresponding to blue, green, and red are respectively a simple wavelength. In this case, blue light is light belonging to wavelength from 430 nm to 470 nm, green light is light belonging to wavelength from 510 nm to 560 nm, and red light is light belonging to wavelength from 600 nm to 660 nm.

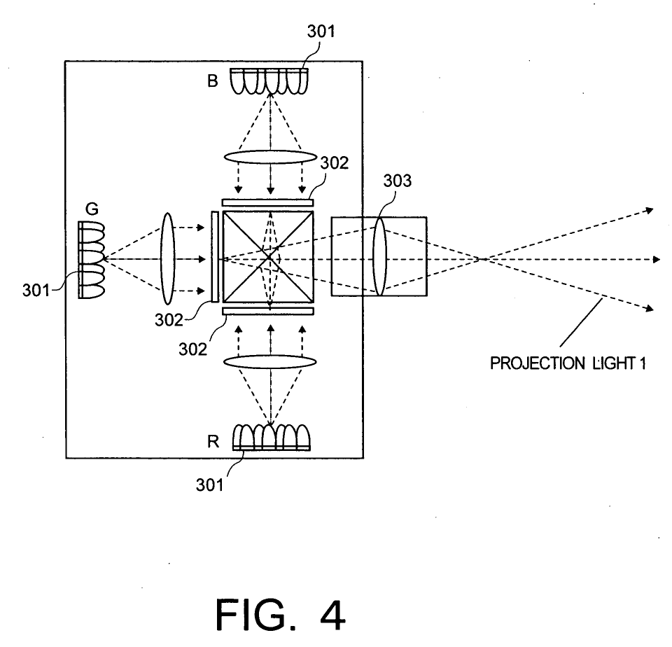

As the light emitting apparatus to obtain such projection light, a 3LCD projector, a DLP projector, or a CRT projector may be used. FIG. 4 shows a projector using an LED array 301 emitting single color (blue, green, red). In the projector of FIG. 4, a light emitted from each LED array 301 (blue, green, red) is projected with spread by a projection lens 303 through an image display device 302 of transparent type corresponding to each color. In this way, the projection light 1 is generated.

The projection light 1 outgoing from the light emitting apparatus 201 may be non-polarized. However, as shown in FIG. 3, linear polarized light having the same polarized direction as a direction of transmission axis of polarized axis of the polarizer 102 is desired. In this case, a polarized direction of a linear polarized direction is called a polarized axis of the linear polarized direction. Hereinafter, assume that the projection light 1 is linear polarized light having a polarized axis in the same direction as a transmission axis of polarized axis of the polarizer 102.

In order for the projection light 1 to be the linear polarized light of polarized axis along a predetermined direction, for example, in a 3LCD projector using a dichroic prism for optical color synthesis, an outgoing direction of polarized axis of LCD (blue, green, red) may be unified. Furthermore, in case of using a DLP projector or a CRT projector to display an image without polarization, a polarized filter may be inserted into a polarized lens.

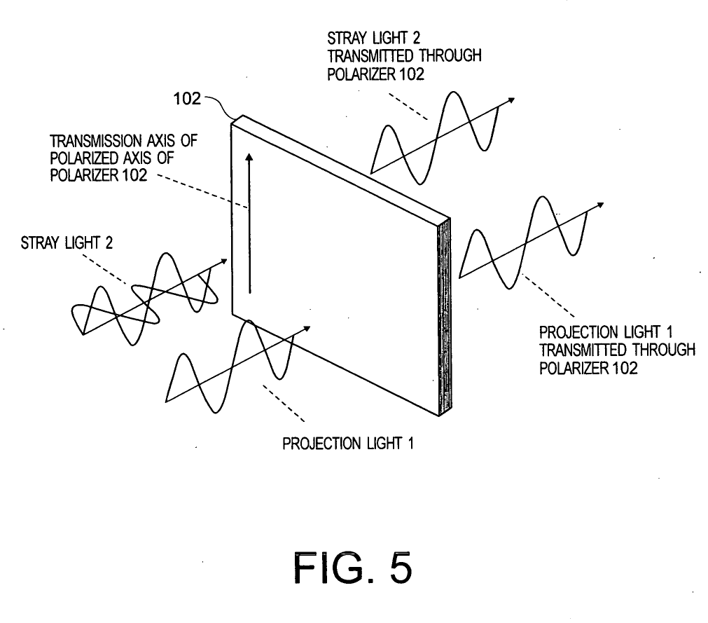

In case that the projection light 1 is linear polarized light having a polarized axis in the same direction as a transmission axis of polarized axis of the polarizer 102, the projection light 1 transmits through the polarizer 102 without absorption by the polarizer 102. On the other hand, a stray light 2 superimposed on the projection light 1 is, in general, non-polarized light. Accordingly, as shown in FIG. 5, in light included in the stray light 2, about half the light is absorbed by the polarizer 102, and about half the light is transmitted by the polarizer 102.

The polarizer 102 having a transmission axis of polarized axis along predetermined direction, which absorbs a light of polarized direction different from the transmission axis of polarized axis, can be obtained by an extend-aligning dichroic molecule (iodine or dyestuffs). For example, SEG1425 series (Nitto Denko Corporation) used for the liquid crystal display on the market can be utilized.

In this way, the projection light 1 and the stray light 2 transmitted from the polarizer 102 are the linear polarized light having a polarized axis along a direction of the transmission axis of polarized axis of the polarizer 102. Next, the projection light 1 and the stray light 2 are incident to the birefringent film layer 103 located behind the polarizer 102.

The birefringent film layer 103 selectively rotates a polarized direction of each incident light from the polarizer 102 (blue, green, red) to a direction perpendicular to the transmission axis of the polarized axis of the polarizer 102.

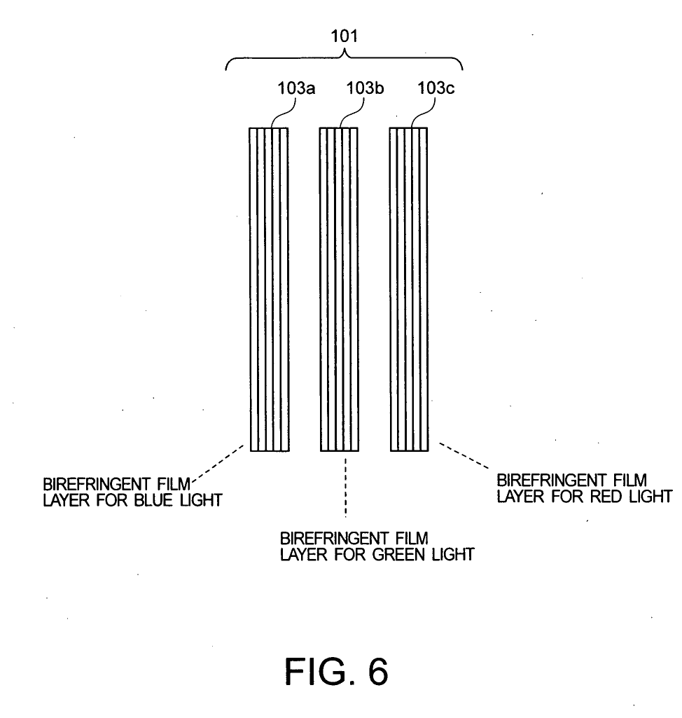

As shown in FIG. 6, the birefringent film layer 103 comprises a birefringent film layer 103a to rotate a polarized direction of blue light, a birefringent film layer 103b to rotate a polarized direction of green light, and a birefringent film layer 103c to rotate a polarized direction of red light.

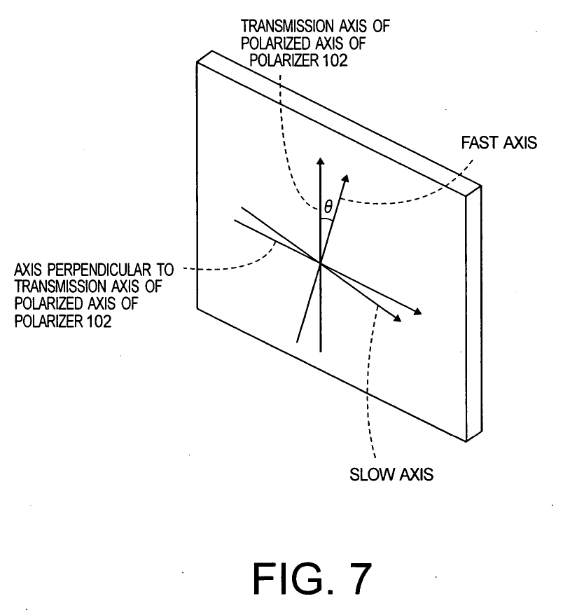

Next, components and functions of each birefringent film layer are explained in detail. As a method for selectively rotating a polarized direction of light of predetermined wavelength, for example, the method disclosed in “I. Solc, “Birefringent Chain Filters”, J. Opt. Soc. America, Vol. 55, pp. 621-625, 1965”. As shown in FIG. 7, in case that the number of layers of the birefringent film layer is N, a direction θ of a fast axis of each layer for a transmission axis of polarized axis of the polarizer 102 is calculated using parameters ρ and α satisfied with equation (1).

$$N \cdot ρ + {( N - 1 )}^{2} \cdot \frac{α}{4} = 45 \qquad ( 1 )$$

In the equation (1), α is a supplemental parameter to determine filter shape, which is an arbitrary constant. Furthermore, the number N is an odd number. In this case, a direction θi f fast axis of the i-th layer from the incident side is calculated by following equation (2).

$${θ}_{i} = {( - 1 )}^{i + 1} \times ( ρ + ( \frac{N - 1}{2} - \vert \frac{N + 1}{2} - i \vert ) \times α ) \qquad ( 2 )$$

A cell gap of each layer is calculated so that a retardation R calculated by equation (3) using birefringent value (Δn) and cell gap (d) is an integral multiple of half wave length of light to be rotated.
R=Δn·d (3)

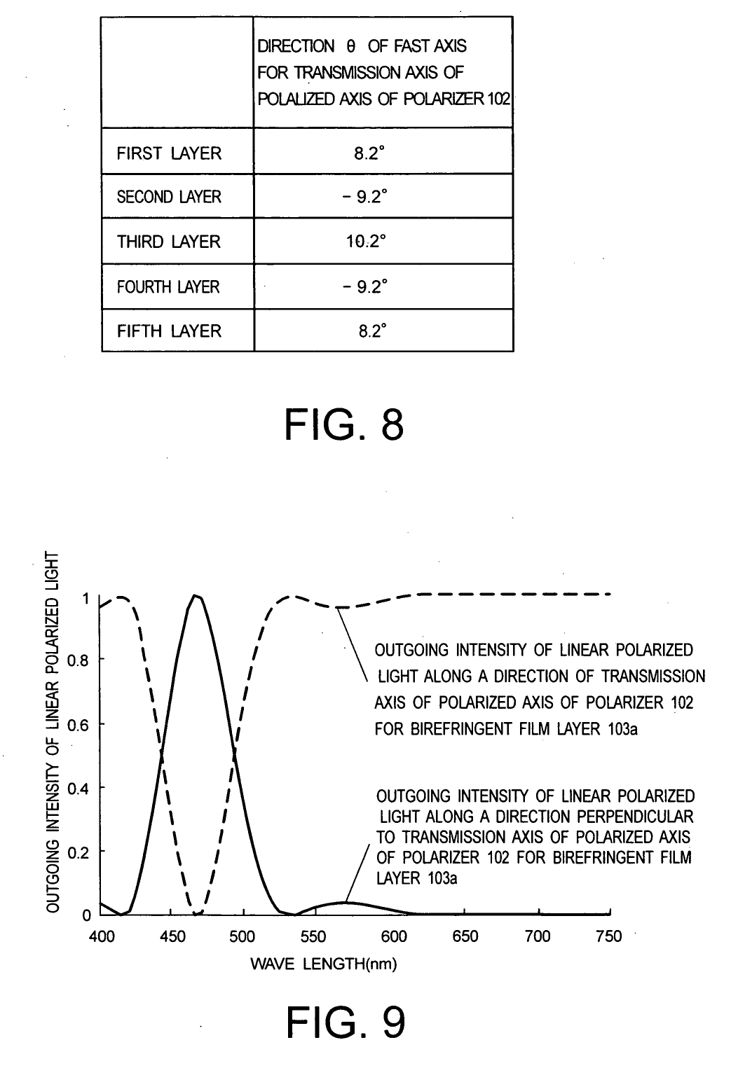

For example, in case that wavelength of blue light is 467 nm, in order to rotate the polarized direction 90° by the birefringent film layer of five layers, the retardation R of each layer is calculated as 700 nm (=467×1.5 (nm)). As shown in FIG. 8, the birefringent film layer is manufactured by determining a direction of fast axis of each layer. In the design example of the birefringent film layer of FIG. 8, assume that α is 1° and ρ is 8.2° by the equation (1). Furthermore, a wavelength of blue light of which polarized direction is rotated by the birefringent film layer 103a is desired to coincide with a wavelength of blue light outgoing from the light emitting apparatus 201.

As for light transmitted from the birefringent film layer 103a, an outgoing intensity of linear polarized light along a transmission axis of polarized axis of the polarizer 102 and an outgoing intensity of linear polarized light along a direction perpendicular to the transmission axis of polarized axis of the polarizer 102 are shown in FIG. 9. In this case, assume that the birefringent value Δn is constant irrespective of the wavelength in the retardation R of the birefringent film layer.

As shown in FIG. 9, in light transmitted from the birefringent film layer 103a, as for a wavelength around 467 nm, an outgoing intensity of linear polarized light along a direction perpendicular to transmission axis of polarized axis of the polarizer 102 is large. Briefly, the polarized direction is rotated to a direction perpendicular to the transmission axis of polarized axis of the polarizer 102 by the birefringent film layer 103a. On the other hand, as for another wavelength, an outgoing intensity of linear polarized light along the transmission axis of polarized axis of the polarizer 102 is large. Briefly, the polarized axis transmitted through the birefringent film layer 103a is not rotated.

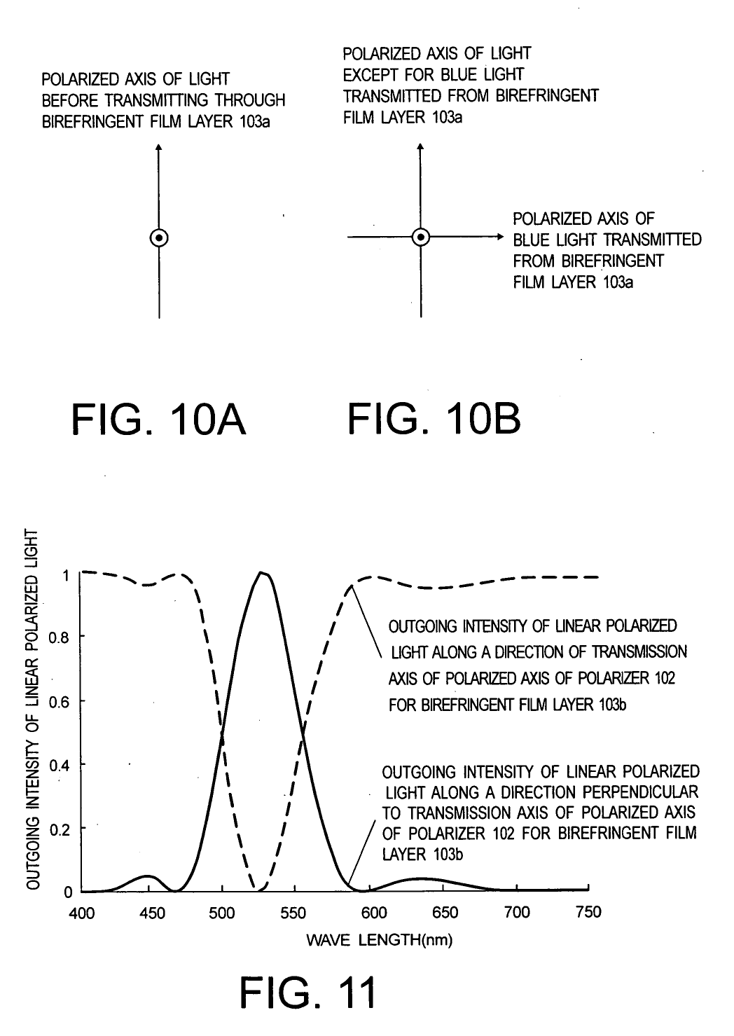

As shown in FIG. 10A, thepolarizer 102 transmits linear polarized light having a polarized axis along the transmission axis of polarized axis of the polarizer 102. In this case, after transmitting through the birefringent film layer 103a, a polarized axis of blue light is rotated to a direction perpendicular to the transmission axis of polarized axis of the polarizer 102 as shown in FIG. 10B.

For example, by extend-aligning a high molecule such as polycarbonate, this birefringent film layer can be obtained with birefringent function. NRF series or NRZ series (Nitto Denko Corporation) may be used. Furthermore, Arton (JSR Corporation) and Zeonoh (Japan Zeon Corporation) have characteristics that the birefringent value Δn almost does not change by wavelength of transmitted light, which are superior for robust environmental ability. Accordingly, they are suitable for the birefringent film layer of the projection type screen of the present embodiment. Furthermore, in general, the larger the number of the birefringent film layers is, the narrower the wavelength region to rotate the polarized direction is. Accordingly, a wavelength region to rotate a polarized direction of a light and a wavelength region to transmit the light without rotation of the polarized direction can be accurately separated. Preferably, the number N of layers of the birefringent film layer is 3˜9.

Next, after rotating the polarized axis of blue light by the birefringent film layer 103a, the light is incident to the birefringent film layer 103b to selectively rotate a polarized axis of green light.

As for the birefringent film layer 103b, in the same way as the birefringent film layer 103a, a direction of fast axis of each layer is calculated by the equation (2) using ρ and α satisfied with equation (1). A cell gap of each layer is calculated so that a retardation R of each layer is an integral multiple of half wave length of green light.

For example, in case that wavelength of green light is 527 nm, in order to rotate the polarized direction 90° by the birefringent film layer of five layers, the retardation R of each layer is calculated as 790 nm (=527×1.5 (nm)). As shown in FIG. 8, the birefringent film layer is manufactured by determining a direction of fast axis of each layer.

As for light transmitted from the birefringent film layer 103b, an outgoing intensity of linear polarized light along a transmission axis of polarized axis of the polarizer 102 and an outgoing intensity of linear polarized light along a direction perpendicular to the transmission axis of polarized axis of the polarizer 102 are shown in FIG. 11. In this case, assume that the birefringent value Δn is constant irrespective of the wavelength in the retardation R of the birefringent film layer.

As shown in FIG. 11, in a light transmitted from the birefringent film layer 103b, as for a wavelength around 527 nm, an outgoing intensity of linear polarized light along a direction perpendicular to transmission axis of polarized axis of the polarizer 102 is large. Briefly, the polarized direction is rotated to a direction perpendicular to the transmission axis of polarized axis of the polarizer 102 by the birefringent film layer 103b. On the other hand, as for another wavelength, an outgoing intensity of linear polarized light along the transmission axis of polarized axis of the polarizer 102 is large. Briefly, the polarized axis transmitted through the birefringent film layer 103b is not rotated.

When light is transmitted through the birefringent film layer 103b after transmitting through the birefringent film layer 103a, polarized axes of blue light and green light are respectively rotated to a direction perpendicular to the transmission axis of polarized axis of the polarizer 102.

Next, after respectively rotating the polarized axes of blue light and green light by the birefringent film layers 103a and 103b, the light is incident to the birefringent film layer 103c to selectively rotate a polarized axis of red light.

As for the birefringent film layer 103c, in the same way as the birefringent film layers 103a and 103b, a direction of fast axis of each layer is calculated by the equation (2) using ρ and Δ satisfied with equation (1). A cell gap of each layer is calculated so that a retardation R of each layer is an integral multiple of half wave length of red light.

For example, in case that wavelength of red light is 633 nm, in order to rotate the polarized direction as 90° by the birefringent film layer of five layers, the retardation R of each layer is calculated as 950 nm (=633×1.5 (nm)). As shown in FIG. 8, the birefringent film layer is manufactured by determining a direction of fast axis of each layer.

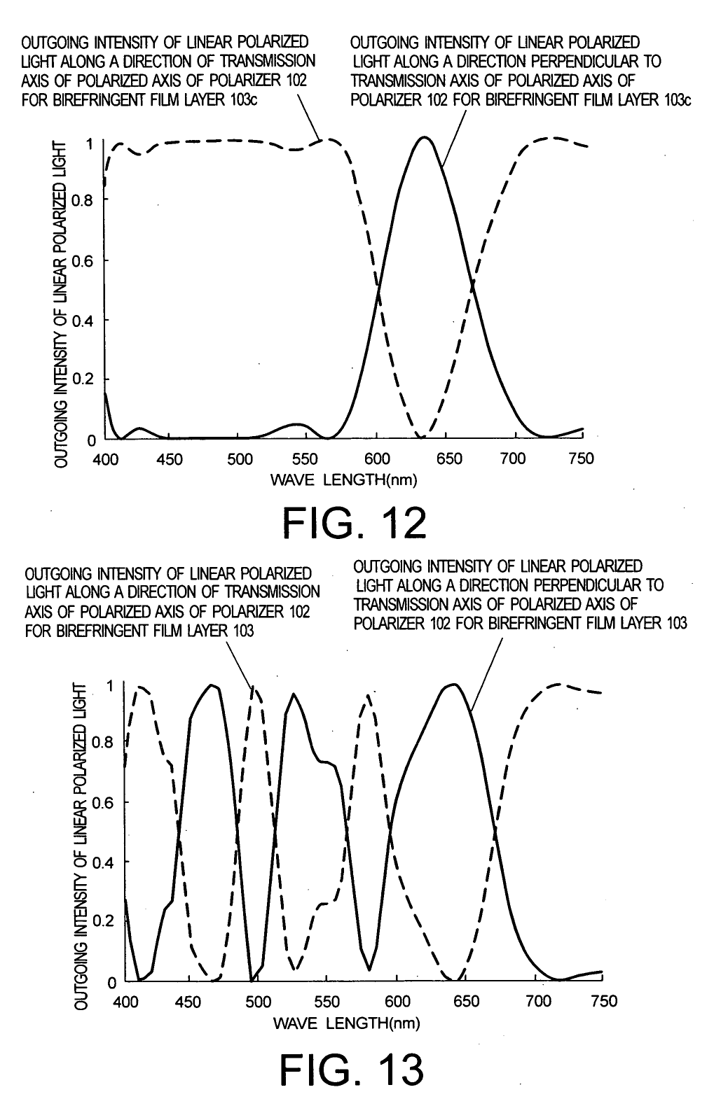

As for a light transmitted from the birefringent film layer 103c, an outgoing intensity of linear polarized light along a transmission axis of polarized axis of the polarizer 102 and an outgoing intensity of linear polarized light along a direction perpendicular to the transmission axis of polarized axis of the polarizer 102 are shown in FIG. 12. In this case, assume that the birefringent value Δn is constant irrespective of the wavelength in the retardation R of the birefringent film layer.

As shown in FIG. 12, in a light transmitted from the birefringent film layer 103c, as for a wavelength around 633 nm, an outgoing intensity of linear polarized light along a direction perpendicular to transmission axis of polarized axis of the polarizer 102 is large. Briefly, the polarized direction is rotated to a direction perpendicular to the transmission axis of polarized axis of the polarizer 102 by the birefringent film layer 103c. On the other hand, as for another wavelength, an outgoing intensity of linear polarized light along the transmission axis of polarized axis of the polarizer 102 is large. Briefly, the polarized axis transmitted through the birefringent film layer 103c is not rotated.

When light is transmitted through the birefringent film layer 103c after transmitting through the birefringent film layers 103a and 103b, polarized axes of blue light, green light, and red light are rotated to a direction perpendicular to the transmission axis of polarized axis of the polarizer 102.

Furthermore, as for light transmitted from the birefringent film layers 103a, 103b, and 103c, an outgoing intensity of linear polarized light along a transmission axis of polarized axis of the polarizer 102 and an outgoing intensity of linear polarized light along a direction perpendicular to the transmission axis of polarized axis of the polarizer 102 are shown in FIG. 13. As shown in FIG. 13, in a light transmitted from the birefringent film layers 103a, 103b, and 103c, as for a wavelength around 467 nm (blue), 527 nm (green), and 633 nm (red), an outgoing intensity of linear polarized light along a direction perpendicular to transmission axis of polarized axis of the polarizer 102 is large. Briefly, the polarized direction is rotated to a direction perpendicular to the transmission axis of polarized axis of the polarizer 102 by the birefringent film layer 103. On the other hand, as for another wavelength, an outgoing intensity of linear polarized light along the transmission axis of polarized axis of the polarizer 102 is large. Briefly, the polarized axis transmitted through the birefringent film layer 103 is not rotated.

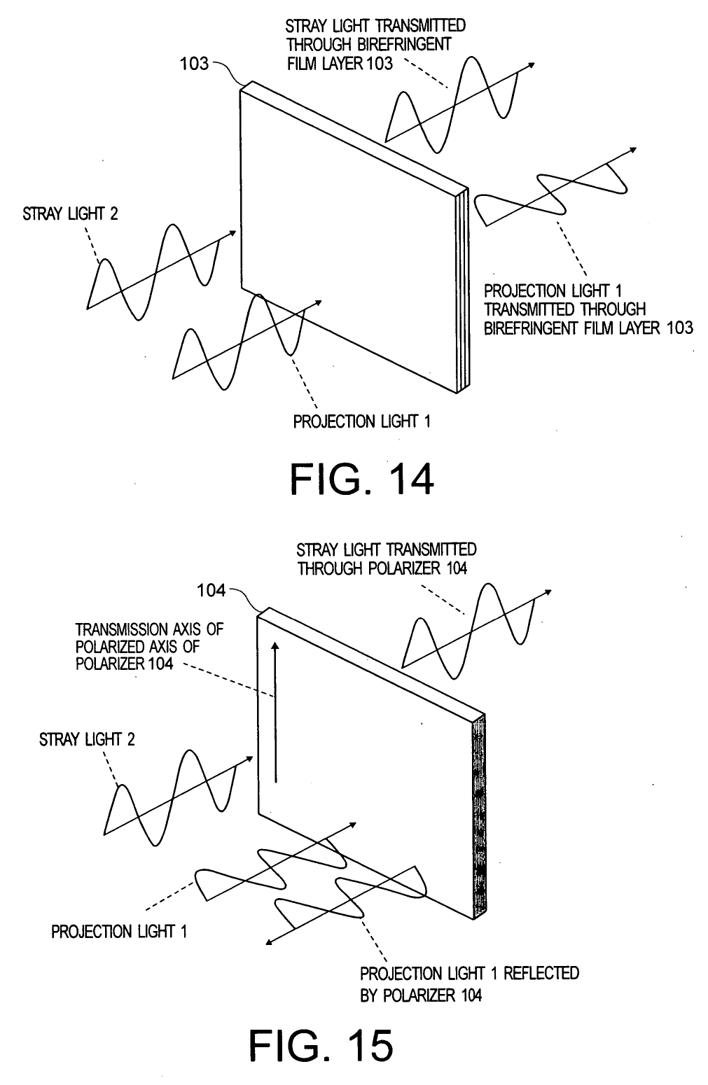

As shown in FIG. 14, by transmitting a projection light 1 and a stray light 2 through the birefringent film layer 103, polarized axes of blue, green, and red in the projection light 1 are rotated to a direction perpendicular to the transmission axis of polarized axis of the polarizer 102.

Next, after transmitting from the birefringent film layer 103, the light is incident to the polarizer 104. As mentioned-above, the polarizer 104 has a transmission axis of polarized axis along the same direction as the transmission axis of polarized axis of the polarizer 102, and reflects a light of a polarized direction different from the transmission axis of polarized axis. Accordingly, in a light transmitted from the birefringent film layer 103, a projection light 1 of which polarized direction is rotated by the birefringent film layer 103 is reflected by the polarizer 104 as shown in FIG. 15. On the other hand, a polarized direction of the stray light 2 is not rotated by the birefringent film layer 103, and the polarized direction is the same as the transmission axis of polarized direction of the polarizer 104. Accordingly, the stray light 2 transmitted from the birefringent film layer 103 is transmitted through the polarizer 104 as shown in FIG. 15.

The polarizer 104 has a transmission axis of polarized direction along a predetermined direction and reflects a light of polarized direction different from the predetermined direction. For example, such polarizer 104 is obtained by laminating with optical interference gap, a medium of birefringent phase difference and an isotropic index medium having refractive index same as one refractive index of the medium. DBEF (Sumitomo 3M Corporation) may be used.

Next, the stray light 2 transmitted from the polarizer 104 is absorbed by a substrate screen material 105. For example, the substrate screen material 105 is formed by a medium having black color such as a board coated by black paint, or a medium having scattering transmittance such as cloth of velvet feathers.

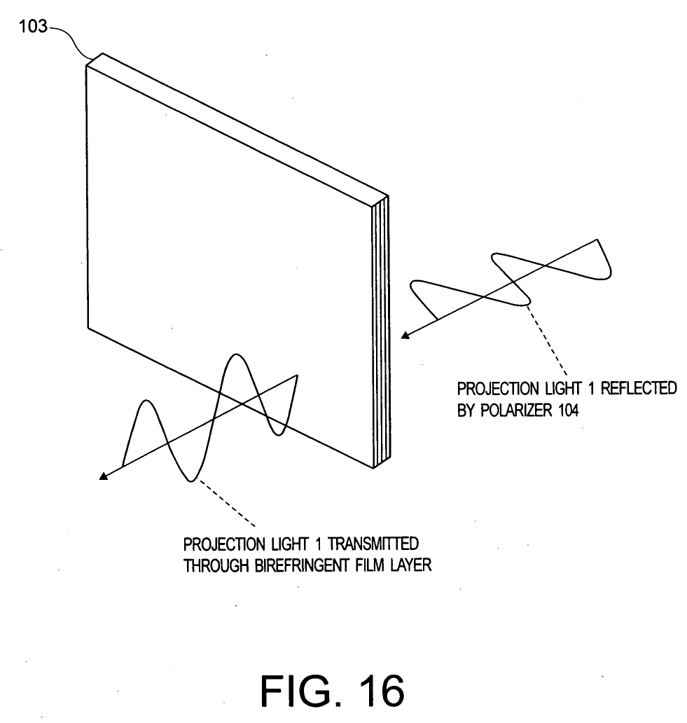

On the other hand, the projection light 1 is reflected by the polarizer 104, and incident to the birefringent film layer 103 again. The birefringent film layer 103 rotates a polarized axis of the reflected light in a reverse direction compared with rotation of the polarized axis of the incident light. Accordingly, as shown in FIG. 16, as for the projection light 1 of which polarized axis was rotated to a direction perpendicular to a transmission axis of polarized axis of the polarizer 102, the polarized axis is reversely rotated to a direction of the transmission axis of polarized axis of the polarizer 102. Then, the projection light 1 transmitted from the birefringent film layer 103 is transmitted through the polarizer 102.

In this way, as shown in FIG. 2, the projection light 1 transmitted from the polarizer 102 is a reflection light 3 by the projection type screen 3. The observer can view the reflection light 3 as a projected image on the projection type screen 101.

As mentioned-above, in the projection type screen of the first embodiment, by rotating a polarized axis of a projection light 1 using the birefringent film layer 103, the projection light 1 is separated from a stray light 2 and selectively reflected. As a result, contrast of projected image on the screen rises. Furthermore, the birefringent film layer 103 is manufactured by roll-process such as extend-processing of film material. Accordingly, the birefringent film layer can be applied to a screen of large area. Furthermore, the screen can be enlarged by connecting a plurality of birefringent film layers as tile shape. Accordingly, in case of using the birefringent film layer, contrast of projected image on the screen can be kept with high contrast even if the area of the screen is large.

In the first embodiment, the number of layers of the birefringent film layers 103a, 103b, and 103c are respectively five (N=5). However, as shown in FIGS. 9, 11, and 12, in the case that the number of layers of each birefringent film layer is equal, the larger the wavelength of light having polarized axis to be rotated is, the wider the wavelength region of light of which polarized axis is rotated is. Accordingly, assume that the number of layers of the birefringent film layer 103a to rotate a polarized direction of blue light is N_{B}, the number of layers of the birefringent film layer 103b to rotate a polarized direction of green light is N_{G}, and the number of layers of the birefringent film layer 103c to rotate a polarized direction of red light is N_{R}. By determining the number of layers based on equation (4), a range of wavelength region of each color (blue, green, red) in which polarized axis is rotated can be almost equal.
N_{B}≦N_{G}≦N_{R} (4)

For example, the number of layers of each color is set as “(N_{B},N_{G},N_{R})=(5, 7, 9)”. Briefly, while wavelength of color light to be rotated becomes large, the number of layers of the birefringent film layer for the color light is set as larger number.

### The Second Embodiment

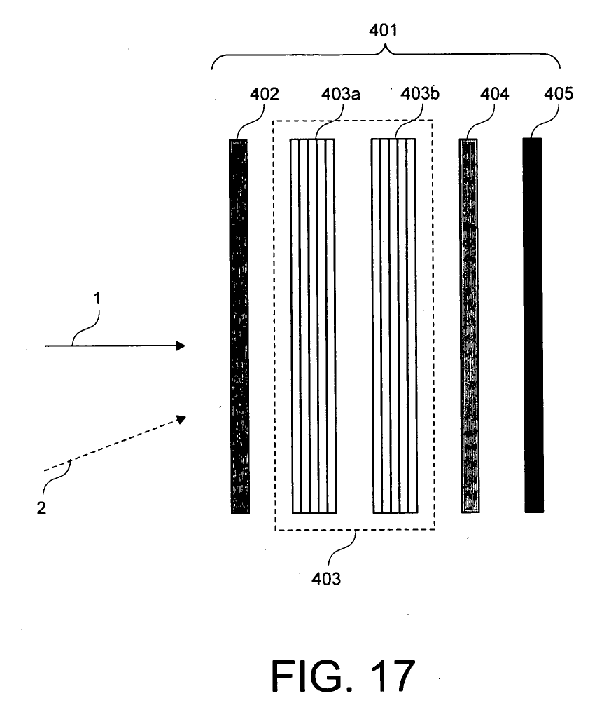

In the first embodiment, by rotating a polarized direction of blue light, green light, and red light in projection light, the projection light is separated from a stray light. However, in the second embodiment, by rotating a light of a wavelength region different from wavelength regions of blue light, green light and red light in a projection light, the projection light is separated from a stray light. FIG. 17 is a component of the projection type screen according to the second embodiment of the present invention.

The projection type screen 401 of the second embodiment comprises the following units. A first polarizer 402 transmits incident light of a first polarized direction and absorbs incident light of a polarized direction different from the first polarized direction. A birefringent film layer 403 rotates a polarized direction of light transmitted through the first polarizer 402 of predetermined wavelengths to a second direction perpendicular to the first polarized direction. A second polarizer 404 transmits a light of the second polarized direction, and reflects a light of a polarized direction different from the second polarized direction. A substrate screen material 405 absorbs light transmitted through the second polarizer 404.

The birefringent film layer 403 comprises the following units. A first birefringent film layer 403a rotates a polarized direction of light of a middle wavelength between blue light and green light to a direction perpendicular to a transmission axis of polarized axis of the polarizer 402. A second birefringent film layer 403b rotates a polarized direction of light of a middle wavelength between green light and red light to a direction perpendicular to the transmission axis of polarized axis of the polarizer 402. In this case, the middle wavelength between blue light and green light is a wavelength region from 470 nm to 500 nm, and the middle wavelength between green light and red light is a wavelength region from 560 nm to 600 nm.

In the second embodiment, component and function of the birefringent film layer 403 and the polarizer 404 are different from the first embodiment. Hereinafter, explanation of units of which component and function are the same as the first embodiment (the polarizer 402 and the screen material 405 of substrate) is omitted.

By transmitting through the polarizer 402, a projection light 1 and a stray light 2 respectively become a linear polarized light having a polarized axis along a transmission axis of polarized axis of the polarizer 402. Next, the projection light 1 and the stray light 2 are incident to the birefringent film layer 403 located behind the polarizer 402.

In the stray light 2 included in the incident light transmitted from the polarizer 402, the birefringent film layer 403 respectively rotates a polarized direction of a light of the middle wavelength between blue light and green light and a polarized direction of a light of the middle wavelength between green light and red light to a direction perpendicular to the transmission axis of polarized axis of the polarizer 402.

First, the birefringent film layer 403a rotates a polarized direction of incident light of the middle wavelength between blue light and green light.

As for the birefringent film layer 403a which selectively rotates a polarized axis of light of middle wavelength between blue and green, in the same way as the birefringent film layer 103a, a direction of fast axis of each layer is calculated by the equation (2) using ρ and α satisfied with equation (1). A cell gap of each layer is calculated so that a retardation R of each layer is an integral multiple of half wave length of light of polarized axis to be rotated in light of the middle wavelength between blue and green.

For example, in case that the wavelength is 490 nm, in order to rotate the polarized direction as 90° by the birefringent film layer of five layers, the retardation R of each layer is calculated as 735 nm (=490×1.5 (nm)). As shown in FIG. 8, the birefringent film layer is manufactured by determining a direction of fast axis of each layer.

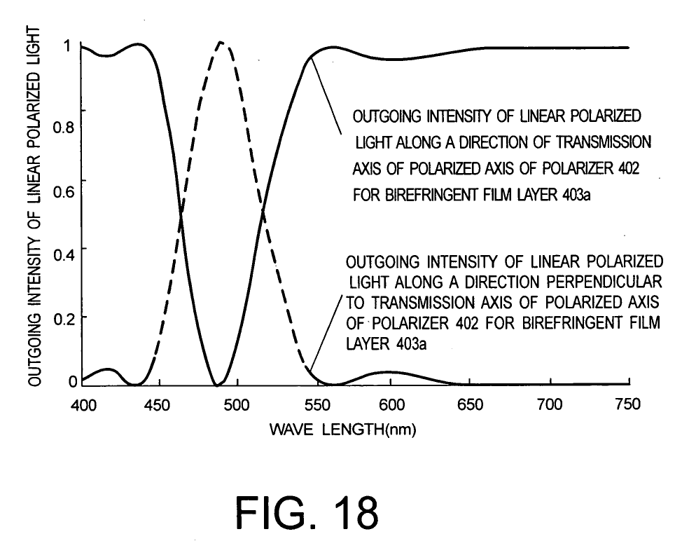

As for a light transmitted from the birefringent film layer 403a, an outgoing intensity of linear polarized light along a transmission axis of polarized axis of the polarizer 402 and an outgoing intensity of linear polarized light along a direction perpendicular to the transmission axis of polarized axis of the polarizer 402 are shown in FIG. 18. In this case, assume that the birefringent value Δn is constant irrespective of the wavelength in the retardation R of the birefringent film layer.

As shown in FIG. 18, in a light transmitted from the birefringent film layer 403a, as for a wavelength around 490 nm, an outgoing intensity of linear polarized light along a direction perpendicular to a transmission axis of polarized axis of the polarizer 402 is large. Briefly, the polarized direction is rotated to a direction perpendicular to the transmission axis of polarized axis of the polarizer 402 by the birefringent film layer 403a. On the other hand, as for another wavelength, an outgoing intensity of linear polarized light along the transmission axis of polarized axis of the polarizer 402 is large. Briefly, the polarized axis transmitted through the birefringent film layer 403a is not rotated.

When light is transmitted through the birefringent film layer 403a, a polarized axis of light of the middle wavelength between blue and green is rotated to a direction perpendicular to the transmission axis of polarized axis of the polarizer 402.

Next, after rotating the polarized axis of the light of the middle wavelength between blue and green by the birefringent film layers 403a, the light is incident to the birefringent film layer 403b. The birefringent film layer 403b rotates a polarized axis of incident light of the middle wavelength between green and red.

As for the birefringent film layer 403b which selectively rotates a polarized axis of light of middle wavelength between green and red, in the same way as the birefringent film layer 403a, a direction of fast axis of each layer is calculated by the equation (2) using ρ and α satisfied with equation (1). A cell gap of each layer is calculated so that a retardation R of each layer is an integral multiple of half wave length of a light of polarized axis to be rotated in a light of the middle wavelength between green and red.

For example, in case that the wavelength is 580 nm, in order to rotate the polarized direction as 90° by the birefringent film layer of five layers, the retardation R of each layer is calculated as 870 nm (=580×1.5 (nm)). As shown in FIG. 8, the birefringent film layer is manufactured by determining a direction of fast axis of each layer.

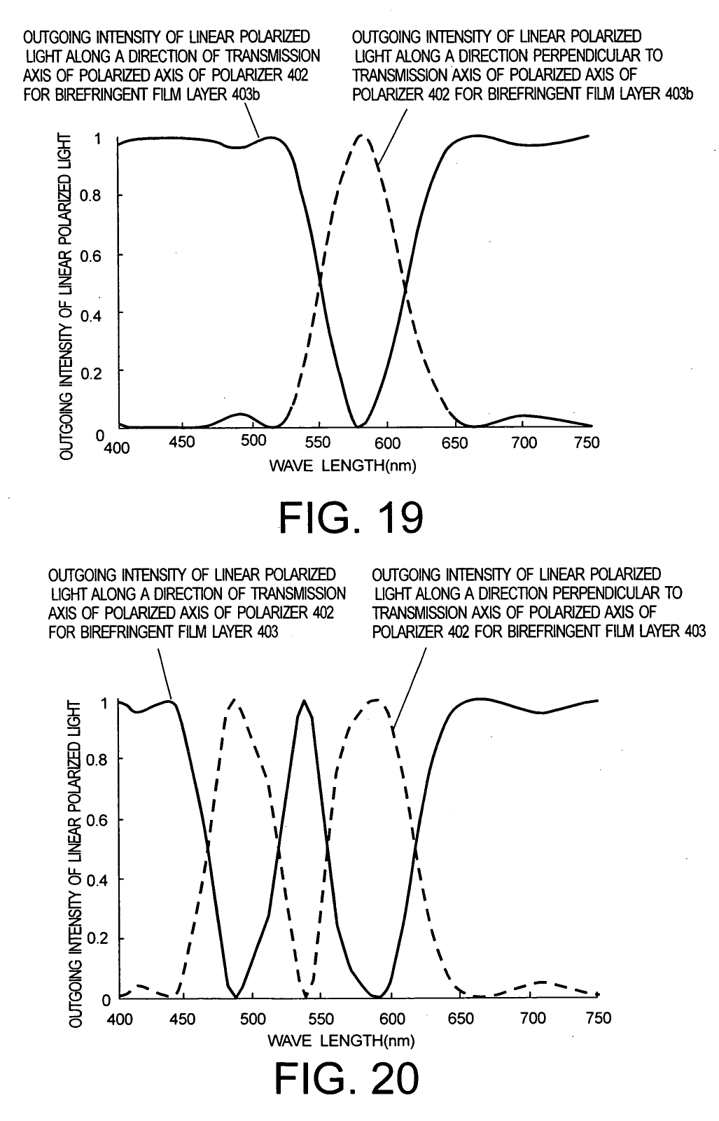

As for a light transmitted from the birefringent film layer 403b, an outgoing intensity of linear polarized light along a transmission axis of polarized axis of the polarizer 402 and an outgoing intensity of linear polarized light along a direction perpendicular to the transmission axis of polarized axis of the polarizer 402 are shown in FIG. 19. In this case, assume that the birefringent value Δn is constant irrespective of the wavelength in the retardation R of the birefringent film layer.

As shown in FIG. 19, in light transmitted from the birefringent film layer 403b, as for a wavelength around 580 nm, an outgoing intensity of linear polarized light along a direction perpendicular to a transmission axis of polarized axis of the polarizer 402 is large. Briefly, the polarized direction is rotated to a direction perpendicular to the transmission axis of polarized axis of the polarizer 402 by the birefringent film layer 403b. On the other hand, as for another wavelength, an outgoing intensity of linear polarized light along the transmission axis of polarized axis of the polarizer 402 is large. Briefly, the polarized axis transmitted through the birefringent film layer 403b is not rotated.

When light is transmitted through the birefringent film layer 403b after transmitting from the birefringent film layer 403a, a polarized axis of a light of the middle wavelength between blue and green and a polarized axis of a light of the middle wavelength between green and red are rotated to a direction perpendicular to the transmission axis of polarized axis of the polarizer 402.

Furthermore, as for light transmitted from the birefringent film layers 403a and 403b, an outgoing intensity of linear polarized light along a transmission axis of polarized axis of the polarizer 402 and an outgoing intensity of linear polarized light along a direction perpendicular to the transmission axis of polarized axis of the polarizer 402 are shown in FIG. 20. As shown in FIG. 20, in light transmitted from the birefringent film layers 403a and 403b, as for a wavelength around 490 nm (middle wavelength between blue and green) and 580 nm (middle wavelength between green and red), an outgoing intensity of linear polarized light along a direction perpendicular to transmission axis of polarized axis of the polarizer 402 is large. Briefly, the polarized direction is rotated to a direction perpendicular to the transmission axis of polarized axis of the polarizer 402 by the birefringent film layer 403. On the other hand, as for another wavelength, an outgoing intensity of linear polarized light along the transmission axis of polarized axis of the polarizer 402 is large. Briefly, the polarized axis transmitted through the birefringent film layer 403 is not rotated.

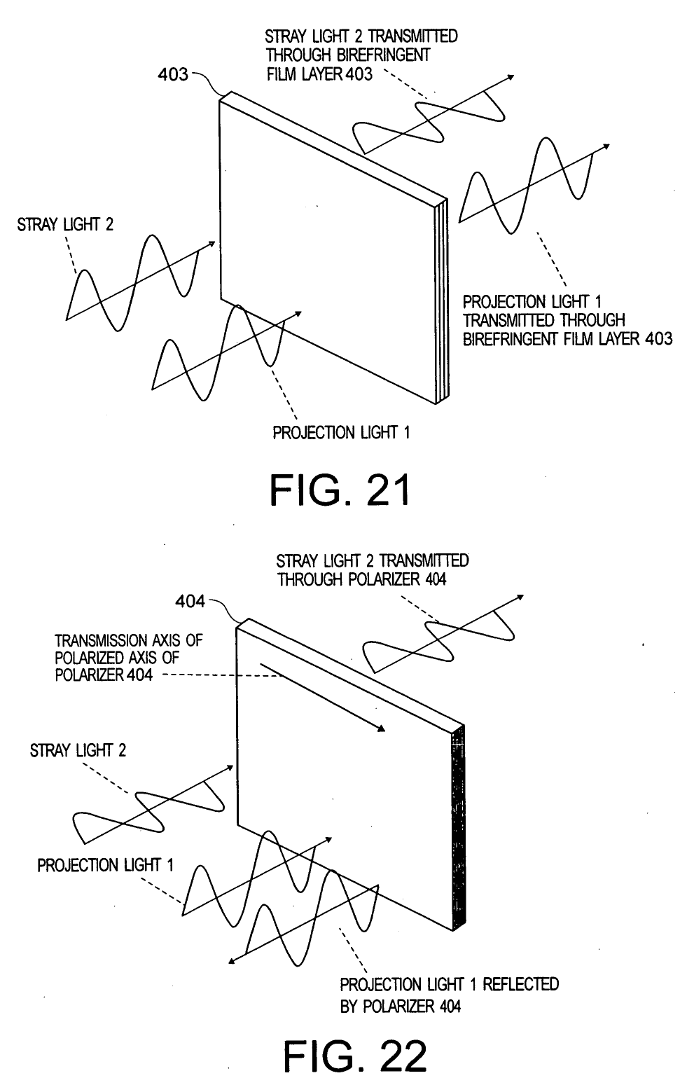

As shown in FIG. 21, by transmitting projection light 1 and stray light 2 through the birefringent film layer 403, a polarized axis of light of middle wavelength between blue and green and a polarized axis of light of middle wavelength between green and red in the stray light 2 are rotated to a direction perpendicular to the transmission axis of polarized axis of the polarizer 402. In this case, in the stray light 2, a light of a wavelength lower than a wavelength of blue light and a light of a wavelength higher than a wavelength of red light are transmitted through the birefringent film layer 403 without rotating the polarized axis. This feature is omitted in FIG. 21.

Next, after transmitting from the birefringent film layer 403, the light is incident to the polarizer 404. As mentioned-above, the polarizer 404 has a transmission axis of polarized axis along a direction perpendicular to a transmission axis of polarized axis of the polarizer 402, and reflects light of a polarized direction different from the transmission axis of polarized axis of the polarizer 404. Accordingly, in light transmitted from the birefringent film layer 403, a projection light 1 of which polarized direction is not rotated by the birefringent film layer 403 is reflected by the polarizer 404. On the other hand, a polarized direction of the stray light 2 is already rotated by the birefringent film layer 403, and the polarized direction is the same as the transmission axis of polarized direction of the polarizer 404. Accordingly, the stray light 2 transmitted from the birefringent film layer 403 is transmitted through the polarizer 404 and absorbed by the substrate screen material 405 as shown in FIG. 22.

The projection light 1 reflected by the polarizer 404 is transmitted along a reverse direction of the incident direction through the birefringent film layer 403. In this case, a polarized direction of the projection light 1 is not rotated by the birefringent film layer 403. Briefly, the polarized direction of the projection light transmitted from the birefringent film layer 403 is parallel to the transmission axis of polarized axis of the polarizer 402. As a result, the projection light 1 is transmitted through the polarizer 402 without absorption by the polarizer 402.

In this way, the projection light 1 transmitted from the polarizer 402 is appeared as a projection image on the projection type screen 401. In this case, a light of middle wavelength between blue and green and a light of middle wavelength between green and red are eliminated as stray light 2. Accordingly, the projection image on the screen is displayed with high contrast.

As mentioned-above, in the projection type screen of the second embodiment, the birefringent film layer 403 rotates a polarized direction of the stray light 2 in a light incident to the projection type screen 401. Briefly, the projection light 1 is separated from the stray light 2 and selectively reflected. As a result, contrast of the projected image on the screen heightens.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A projection type screen, comprising:
a first polarizer configured to transmit incident light of a first polarized direction and to absorb incident light of a polarized direction different from the first polarized direction;
a birefringent film layer behind the first polarizer along a direction of the incident light, configured to rotate a polarized direction of light transmitted through the first polarizer of a predetermined wavelength to a second polarized direction different from the first polarized direction;
a second polarizer behind the birefringent film layer along the direction of the incident light, configured to transmit light transmitted through the birefringent film layer of the first polarized direction and to reflect light transmitted through the birefringent film layer of the second polarized direction; and
a substrate behind the second polarizer along the direction of the incident light, configured to absorb light transmitted through the second polarizer.

2. A projection type screen, comprising:
a first polarizer configured to transmit incident light of a first polarized direction and to absorb incident light of a polarized direction different from the first polarized direction;
a birefringent film layer behind the first polarizer along a direction of the incident light, configured to rotate a polarized direction of light transmitted through the first polarizer of a predetermined wavelength to a second polarized direction different from the first polarized direction;
a second polarizer behind the birefringent film layer along the direction of the incident light, configured to reflect light transmitted through the birefringent film layer of the first polarized direction and to transmit light transmitted through the birefringent film layer of the second polarized direction; and
a substrate behind the second polarizer along the direction of the incident light, configured to absorb light transmitted through the second polarizer.

3. The projection type screen according to claim 1,
wherein the predetermined wavelength includes a range from 430 nm to 470 nm, a range from 510 nm to 560 nm, and a range from 600 nm to 660 nm.

4. The projection type screen according to claim 1,
wherein the birefringent film layer comprises:
a first birefringent film layer configured to rotate a polarized direction of light of a wavelength from 430 nm to 470 nm to the second polarized direction,
a second birefringent film layer configured to rotate a polarized direction of light of a wavelength from 510 nm to 560 nm to the second polarized direction, and
a third birefringent film layer configured to rotate a polarized direction of light of a wavelength from 600 nm to 660 nm to the second polarized direction.

5. The projection type screen according to claim 4,
wherein the second polarized direction is perpendicular to the first polarized direction.

6. The projection type screen according to claim 4,
wherein each of birefringent films includes a number of layers,
wherein the number of layers in the first birefringent film layer is not above the number of layers in the second birefringent film layer, and
wherein the number of layers in the second birefringemt film layer is not above the number of layers in the third birefringent film layer.

7. The projection type screen according to claim 2,
wherein the predetermined wavelength includes a range from 470 nm to 500 nm, and a range from 560 nm to 600 nm.

8. The projection type screen according to claim 2,
wherein the birefringent film layer comprises:
a first birefringent film layer configured to rotate a polarized direction of light of a wavelength from 470 nm to 500 nm to the second polarized direction, and
a second birefringent film layer configured to rotate a polarized direction of light of a wavelength from 560 nm to 600 nm to the second polarized direction.

9. The projection type screen according to claim 8,
wherein the second polarized direction is perpendicular to the first polarized direction.

10. The projection type screen according to claim 8,
wherein each of birefringent films includes a number of layers,
wherein the number of layers in the first birefringent film layer is not above the number of layers in the second birefringent film layer.

11. An image projection system, comprising:
a projection type screen; and
a light emitting apparatus configured to emit light of a predetermined wavelength as linear polarized light of a first polarized direction;
wherein the projection type screen comprises:
a first polarizer configured to transmit incident light of the first polarized direction and to absorb incident light of a polarized direction different from the first polarized direction;
a birefringent film layer behind the first polarizer along a direction of the incident light, configured to rotate a polarized direction of light transmitted through the first polarizer of the predetermined wavelength to a second polarized direction different from the first polarized direction;
a second polarizer behind the birefringent film layer along the direction of the incident light, configured to transmit light transmitted through the birefringent film layer of the first polarized direction and to reflect light transmitted through the birefringent film layer of the second polarized direction; and
a substrate behind the second polarizer along the direction of the incident light, configured to absorb light transmitted through the second polarizer.

12. An image projection system, comprising:
a projection type screen; and
a light emitting apparatus configured to emit light of a predetermined wavelength as linear polarized light of a first polarized direction;
wherein the projection type screen comprises:
a first polarizer configured to transmit incident light of the first polarized direction and to absorb incident light of a polarized direction different from the first polarized direction;
a birefringent film layer behind the first polarizer along a direction of the incident light, configured to rotate a polarized direction of light transmitted through the first polarizer of the predetermined wavelength to a second polarized direction different from the first polarized direction;
a second polarizer behind the birefringent film layer along the direction of the incident light, configured to reflect light transmitted through the birefringent film layer of the first polarized direction and to transmit light transmitted through the birefringent film layer of the second polarized direction; and
a substrate behind the second polarizer along the direction of the incident light, configured to absorb light transmitted through the second polarizer.

13. The image projection system according to claim 11,
wherein the predetermined wavelength includes a range from 430 nm to 470 nm, a range from 510 nm to 560 nm, and a range from 600 nm to 660 nm.

14. The image projection system according to claim 11,
wherein the birefringent film layer comprises:
a first birefringent film layer configured to rotate a polarized direction of light of a wavelength from 430 nm to 470 nm to the second polarized direction,
a second birefringent film layer configured to rotate a polarized direction of light of a wavelength from 510 nm to 560 nm to the second polarized direction, and
a third birefringent film layer configured to rotate a polarized direction of light of a wavelength from 600 nm to 660 nm to the second polarized direction.

15. The image projection system according to claim 14,
wherein the second polarized direction is perpendicular to the first polarized direction.

16. The image projection system according to claim 14,
wherein each of birefringent films includes a number of layers,
wherein the number of layers in the first birefringent film layer is not above the number of layers in the second birefringent film layer, and
wherein the number of layers in the second birefringemt film layer is not above the number of layers in the third birefringent film layer.

17. The image projection system according to claim 12,
wherein the predetermined wavelength includes a range from 470 nm to 500 nm, and a range from 560 nm to 600 nm.

18. The image projection system according to claim 12,
wherein the birefringent film layer comprises:
a first birefringent film layer configured to rotate a polarized direction of light of a wavelength from 470 nm to 500 nm to the second polarized direction, and
a second birefringent film layer configured to rotate a polarized direction of light of a wavelength from 560 nm to 600 nm to the second polarized direction.

19. The image projection system according to claim 18,
wherein the second polarized direction is perpendicular to the first polarized direction.

20. The image projection system according to claim 18,
wherein each of birefringent films includes a number of layers,
wherein the number of layers in the first birefringent film layer is not above the number of layers in the second birefringent film layer.
